(19) United States
(12) Patent Application Publication
(10) Pub. No.: US 2016/0240327 A1
(43) Pub. Date: Aug. 18, 2016

(54) CAPACITOR UNIT WITH HIGH-ENERGY STORAGE

(71) Applicant: APAQ TECHNOLOGY CO., LTD., MIAOLI COUNTY (TW)

(72) Inventors: CHING-FENG LIN, HSINCHU COUNTY (TW); MING-TSUNG CHEN, CHANGHUA COUNTY (TW); CHI-HAO CHIU, HSINCHU CITY (TW); CHAI-CHING SUNG, MIAOLI COUNTY (TW)

(21) Appl. No.: 14/753,202

(22) Filed: Jun. 29, 2015

(30) Foreign Application Priority Data
Feb. 17, 2015 (TW) 104105559

(51) Int. Cl. H01G 11/46; H01G 11/56; H01G 11/68; H01G 11/26

(52) U.S. Cl. CPC H01G 11/46; H01G 11/26; H01G 11/56; H01G 11/68

(57) ABSTRACT

The present invention provides a capacitor unit with high-energy storage which includes an electrolyte, a positive electrode, and a negative electrode. The electrolyte includes an electrically conductive polymer composition. The positive and negative electrodes are arranged in the electrolyte. The positive electrode includes a substrate and a transition metal oxide layer formed on the substrate, resulting in the highest possible capacitance density.

### BACKGROUND OF THE INVENTION

1. Field of the Invention

The instant disclosure relates to an electrical energy storage technology; in particular, to a capacitor unit with high-energy storage.

2. Description of Related Art

Due to the serious problem of lack of energy, electrical energy storage technology has gradually developed to meet the requirements of green and electrical power conveyance. The super capacitor is a new energy-storage element, the performance of which is between secondary batteries and conventional capacitors. The super capacitor, of which the capacitance may be even thousands of farads, can be widely used in urban public transportation, wind power generation, hybrid bus, smart power grid, engineering machinery and other fields. The products have been widely acclaimed for their superior performance, which features high power start-up, quick charge, no maintenance and high recycling efficiency.

It is very important for the super capacitor to use a high-voltage-stable electrolyte according to the positive correlation of energy/power density and operation voltage. However, the operating voltage of the capacitor battery is restricted by the conventional water based electrolyte which allows only very low voltage operation (i.e. 1V). On the other hand, non-water-based electrolytes such as organic solvents are usually flammable and volatilizable and thus are unstable upon heating or operation in an electrochemical environment. Therefore, the capacitor battery with the conventional water based electrolyte cannot be operated at higher temperatures.

It is also important for the electrode material affects the expression of the super capacitor. The conventional electrode materials mainly include carbon based material and metal oxide material. Although the carbon based material has a high specific surface area, the electrical conductivity and crystallinity is worsened against the electron transfer in the electrode. Further, the capacitor with the conventional electrode materials usually exhibits a high ESR value, and the utilization rate of its specific surface is always less than 30%. The capacitor cannot be optimized because of these properties.

Carbon nanotubes (CNTs) are seamless tubular crystals having a high specific surface area and high crystallinity formed by a curly graphite layer, and the utilization rate of the high specific surface area can reach 100%. Thus, carbon nanotubes are suitable for electrode material. However, a powder containing carbon nanotubes for making thin-film electrode is easily aggregated, and carbon nanotubes are non-uniformly distributed over the internal and external walls thereof. In addition chemically modified carbon nanotubes can still be aggregated, and the toughness of the resulting thin-film electrode can only get worse.

### SUMMARY OF THE INVENTION

The object of the instant disclosure is to provide a capacitor unit with high-energy storage which exhibits good electrical/chemical properties.

In order to achieve the aforementioned objects, according to the first embodiment of the instant disclosure, the capacitor unit with high-energy storage comprises an electrolyte, a positive electrode, and a negative electrode. The positive electrode is arranged in the electrolyte, having a substrate and a transition metal oxide layer formed on the substrate. The negative electrode is arranged in the electrolyte corresponding to the positive electrode.

In order to achieve the aforementioned objects, according to the second embodiment of the instant disclosure, the capacitor unit with high-energy storage comprises an electrolyte, a positive electrode, and a negative electrode. The positive electrode is arranged in the electrolyte and made of a mixture of a porous carbon material and a nano-scaled transition metal oxide material. The negative electrode is arranged in the electrolyte corresponding to the positive electrode.

Base on the above, a capacitor unit is provided with high-energy storage having the electrolyte containing electrically conductive polymer composition which can cooperate with the transition metal oxide layer to improve electrical conductivity, electrical-chemical stability, and mechanical characteristics.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a perspective view of a capacitor unit with high-energy storage according to a first embodiment of the instant disclosure;

FIG. 2 shows a perspective view of another capacitor unit with high-energy storage according to the first embodiment of the instant disclosure;

FIG. 3 shows a perspective view of still another capacitor unit with high-energy storage according to the first embodiment of the instant disclosure;

FIG. 4 shows a perspective view of a capacitor unit with high-energy storage according to a second embodiment of the instant disclosure; and

FIG. 5 shows a perspective view of a first electrode according to a second embodiment of the instant disclosure.

### DETAILED DESCRIPTION OF THE PREFERRED EMBODIMENTS

The instant disclosure relates to an electrical energy storage system, in which a positive electrode made from transition metal oxide material and an electrolyte containing an electrically conductive polymer composition are used to enhance high-density energy storage and power, preferably at a same charge time. Therefore, said electrical energy storage system can be used in various technical fields, in particular, to the applications of electric vehicles. Specifically, said electrical energy storage system can provides maximum power on demand during the upward motivation of electric vehicles, and receive the entire amount of electricity produced during braking for electric vehicles.

The aforementioned illustrations and following detailed descriptions are exemplary for the purpose of further explaining the scope of the instant disclosure. Other objectives and advantages related to the instant disclosure will be illustrated in the subsequent descriptions and appended drawings.

### The First Embodiment

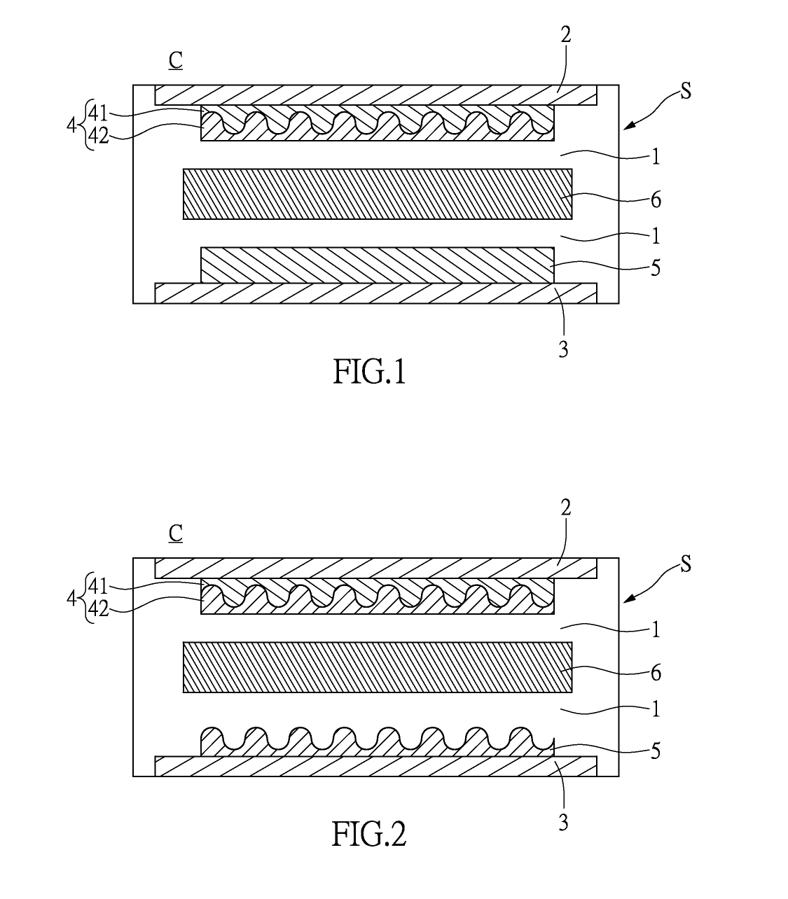

Please refer to FIG. 1, which shows a perspective view of a capacitor unit with high-energy storage according to a first embodiment of the instant disclosure. The capacitor unit C includes an electrolyte 1, a casing S, a first collector 2, a second collector 3, a first electrode 4, a second electrode 5, and separator 6. The following will describe the structural characteristics of all of the essential elements mentioned above, and will then describe the materials of said elements and their properties.

The electrolyte 1 is disposed in the casing S which can be made from glass or stainless steel. The electrolyte 1 can be, but is not limited to, a water-soluble electrolyte, an organic electrolyte, a solid electrolyte, and a gel electrolyte. To further explain the above-mentioned electrolytes, the solid electrolyte includes at least the following advantages: easy to process, long lifetime, good chemical safety, good electrochemical stability, and excellent mechanical characteristics. The gel electrolyte has cohesion of solids and diffusivity of liquids. Moreover, the gel electrolyte includes plasticizer (i.e. low molecular weight polar plasticizer), adapted to transfer a semi-crystallized polymer electrolyte to an amorphous one. Thus, the ion motive energy of a polymer chain can be reduced to enhance ion mobility. The positive ion in the salt can be coordinated by the plasticizer, such that the degree of dissociation of the salt can be reduced. In addition at least a portion of the lithium ions can flow away from the polymer chain to improve the mobility of the polymer chain.

The electrolyte 1 comprises an electrically conductive polymer composition. For the instant embodiment, the electrically conductive polymer composition comprises at least one inherently π conjugated conductive polymer or copolymer selected from polypyrroles, polythiophenes, polyacetylenes, polyphenylenes, polystyrenes, polyanilines, polyacenes, polythienylenevinylenes, or their derivatives. Preferably, the content of said conductive polymer in the electrolyte 1 is about 1-5 wt %, and a conductive passage is thus formed to pass through electrical charges. The resulting capacitor unit C exhibits low equivalent series resistance (ESR) values and high withstand voltage/operating voltage values.

Further, said conductive polymer, in view of stability and polymerization of material, is preferably selected from polypyrroles, polythiophenes, and polyanilines. Functional groups such as alkyl group, carboxyl group, sulfo group, alkoxy group, hydroxyl group, cyano group, etc., can be directed into the conductive polymer to increase its conductivity.

The electrically conductive polymer composition may further comprise an organic salt, a polyanion, and any suitable auxiliary material adapted to improve the properties, for example, conductivity, electrical-chemical stability, and mechanical characteristics. Thus, the capacitor unit C can be minimized and desirably optimized for low ESR and high operating voltage.

For the instant embodiment, the organic salt contains at least one amide group having at least a carbon-oxygen double bond and a carbon-nitrogen single bond. The organic salt can be, but is not limited to, acetamide, urea, methylurea (NMU), 2-oxazolidinone (OZO), ethyleneurea, and 1,3-dimethylurea (DMU). The organic salt that acts as a blend of said conductive polymer can be used to enhance the electrical conductivity and electrical-chemical stability. Preferably, the content of the organic salt in the electrically conductive polymer composition, per 100 wt % of said conductive polymer, is about 1-5 wt %.

The polyanion includes anionic constitutional repeating units. Specifically, the polyanion can be, but is not limited to, polyalkylene, polyethylene, polyimide, polyamide, and/or polymers or copolymers of polyester (substituted or unsubstituted as previously described). The polyanion that acts as a blend of said conductive polymer can be used to enhance the electrical conductivity. For example, the polyanion having a hydroxyl group can more effectively interact with said conductive polymer via cooperative hydrogen bonds.

The auxiliary material is ceramic particles having high surface areas. Specifically, the ceramic particles comprise, but are not limited to, ZrO₂, TiO₂, Al₂O₃, ZrO₂ (oleophilic), and/or glass fibers. The ceramic particles that act as a blend of said conductive polymer can be used to enhance the electrical conductivity, electrical-chemical stability, and mechanical characteristics.

The first collector 2 and the second collector 3 are arranged in the electrolyte 1 corresponding to each other. The first and second collectors 2, 3 can be made from graphite, nickel, aluminum, copper, or etc. In practice, each of the first and second collectors 2, 3, for example, can be a copper sheet, and there is no restriction on the size and shape of the copper sheet. Preferably, each of the first and second collectors 2, 3 is a porous body such as, but is not limited to, a porous aluminum body, porous nickel body, or porous Ni—Cr alloy body. Thereby, most of active substances can be contained in the first and second collectors 2, 3 to reduce the internal resistance (Ri) of the first and second electrodes 4, 5, and a high energy density capacitor unit C can be provided that is capable of operating at high power outputs.

The first electrode 4 that can act as a positive electrode is arranged on and in electrical contact with the surface of the first collector 2. For the instant embodiment, the first electrode 4 comprises a metal substrate 41 and a transition metal oxide layer 42 formed on the metal substrate 41. The metal substrate 41 can be a porous metal substrate such as, but not limited to, aluminum foam structure, nickel foam structure, titanium foam structure, or etc. The transition metal oxide layer 42 can be made from manganese oxide (MnO₂), nickel oxide (NiO), cobalt oxide (Co₃O₄), vanadium oxide (V₂O₅), iridium oxide (IrO₂), or rubidium oxide (RuO₂).

It should be note that a porous metal substrate 41 of the first electrode 4 can be provided to increase usable surface areas, such that the reactive area between the first electrodes 4 and the electrolyte 1 is increased. Thereby, on the reactive area there can be formed an electrical double layer under an electrical field to absorb and store electrons. Moreover, the transition metal oxide layer 42 of the first electrode 4 can store a substantial amount of charges therein and on its surface via rapid oxidation-reduction cycles. Thereby, the operating voltage of the capacitor unit C can be effectively increased (at least two times).

Further, the transition metal oxide layer 42 can act as a pseudo-capacitor of the capacitor unit C. That is, the capacitance of the capacitor unit C can be effectively increased by faradic currents caused by charges at the surface of the transition metal oxide layer 42. The capacitor unit C with the low-cost transition metal oxide layer 42 can exhibit good super capacitor properties.

To further explain the details of the transition metal oxide layer 42, a preferable manufacturing method according to the first embodiment comprises the following steps. The first step is to provide transition metal oxide materials such as, but not limited to, nanosheets, nanoparticles, or nanowires. The next step is to dissolve the transition metal oxide materials in deionized water. The last step is to form the transition metal oxide layer 42 on the metal substrate 41 by anode oxidation. Please note that there is no restriction on the manufacturing method of the transition metal oxide layer 42.

In various embodiments, the transition metal oxide layer 42 can be formed by any other suitable method such as, for example, solid phase method, chemical precipitation method, sol-gel method, hydrothermal method, or molten salt method. Please note that the materials may have different particle sizes, microscopic shapes, levels of aggregation, etc. according to the manufacturing method, and one skilled person in the art can select an appropriate method for the transition metal oxide layer 42.

The second electrode 5 that can act as a negative electrode is arranged on and electrically contacts with the surface of the second collector 3. For the instant embodiment, the second electrode 5 can be made from carbon materials comprising, but not limited to, graphene, carbon nanotubes, carbon blacks, carbon nanofibers, and/or carbon nanocapsules. The second electrode 5 has a high electrode interfacial surface area and a high electrical conductivity, and the second electrode 5 cannot interact with the electrolyte 1. Thus, the second electrode 5 can store a substantial amount of charges on its surface by utilizing the naturally occurring electrical double layer effect as the dielectric.

The separator 6 is arranged between the first and second electrodes 4, 5, and there is no restriction on the material of the separator 6. One example of a widely used commercially available separator is a non-woven cloth.

Please refer to FIG. 2, which shows a perspective view of another capacitor unit with high-energy storage according to the first embodiment. Specifically, the second electrode 5 can be a carbon foam structure to increase its usable surface areas.

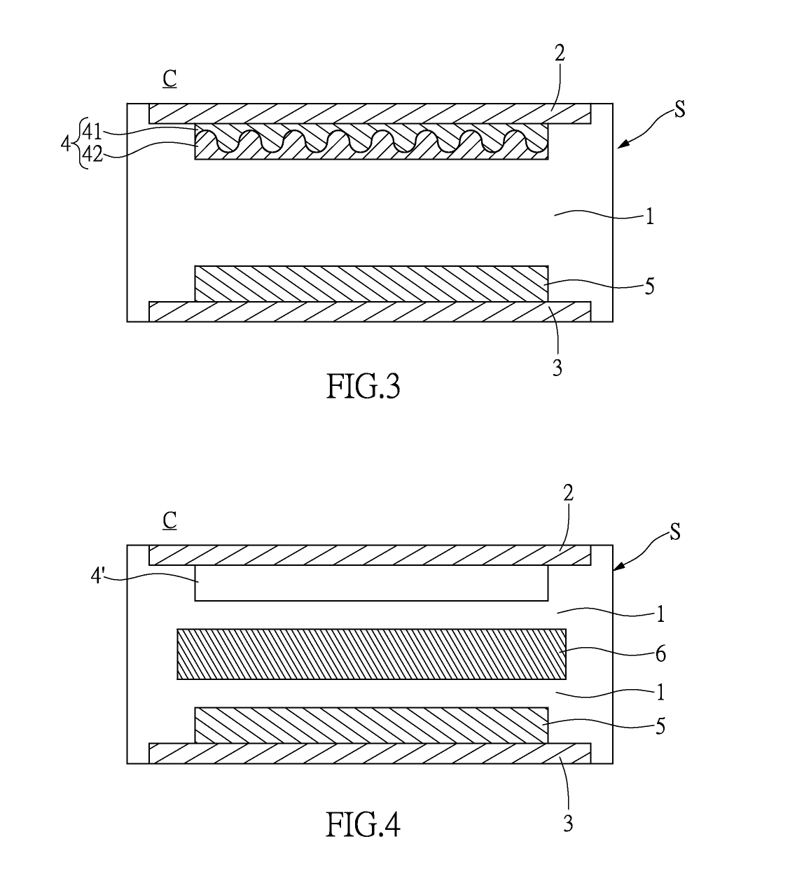

Please refer to FIG. 3, which shows a perspective view of still another capacitor unit with high-energy storage according to the first embodiment. Specifically, there may be no need to use a separator 6 between the first and second electrodes 4, 5 according to actual requirements. The electrolyte 1 is a water-based gel electrolyte with or without the above-mentioned electrically conductive polymer composition. It should be noted that although the capacitor with a water-based electrolyte usually has a low operating voltage value, the operating voltage can be raised from 0.8 V to 2.0 V or more in a safe manner (without burning) by using said water-based gel electrolyte. In addition the omission of the separator 6 can result in lower costs and higher throughput of production.

Referring to FIGS. 1-3, there may be no need to use the first and second collectors 2, 3 according to actual requirements. In practice, the first and second electrodes 4, 5 can be arranged in the electrolyte corresponding to each other by using an electrically conductive adhesive.

### The Second Embodiment

Please refer to FIG. 4, which shows a perspective view of a capacitor unit with high-energy storage according to a second embodiment of the instant disclosure. The capacitor unit C includes an electrolyte 1, a casing S, a first collector 2, a second collector 3, a first electrode 4′, a second electrode 5, and separator 6.

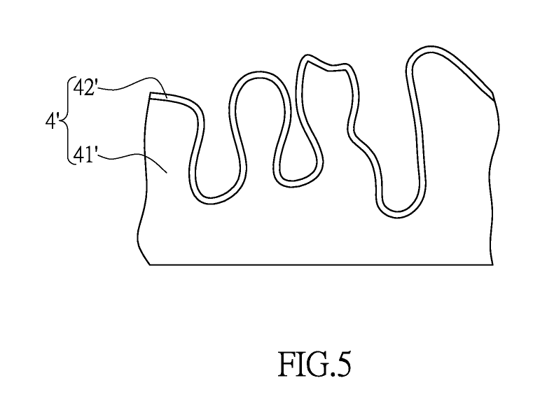

Please refer to FIG. 5, the difference between the first and second embodiments is that the first electrode 4′ is made of a mixture of a porous carbon material 41′ and a nano-scaled transition metal oxide material 42′. For the instant embodiment, the porous carbon material can be made from graphene, carbon nanotubes, carbon nanofibers, carbon nanocapsules, or etc., and adapted to provide a high electrode interfacial surface area for deposition of the transition metal oxide material 42′ and a high electrical conductivity. The transition metal oxide material can be made from manganese oxide (MnO₂), nickel oxide (NiO), cobalt oxide (Co₃O₄), vanadium oxide (V₂O₅), iridium oxide (IrO₂), or rubidium oxide (RuO₂). Please note that there is no restriction on the materials of the porous carbon material 41′ and the transition metal oxide material 42′.

Similarly, there may be no need to use a separator 6 between the first and second electrodes 4′, 5 according to actual requirements. In addition the second electrode 5 can be a carbon foam structure to increase its usable surface areas.

In summary the present invention can provide a capacitor unit with high capacitance and high energy density by the following configurations.

First, the electrolyte containing electrically conductive polymer composition can cooperate with the transition metal oxide layer to improve electrical conductivity, electrical-chemical stability, and mechanical characteristics.

Second, the electrically conductive polymer composition may further comprise an organic salt, a polyanion, and any suitable auxiliary material adapted to enhance the properties, for example, conductivity, electrical-chemical stability, and mechanical characteristics.

Third, the porous metal substrate/carbon material with high specific surface area can be adapted to form more electrical and chemical interfaces under an electrical field. Thus, the resulting electrical double layer can store a substantial amount of charges therein.

Fourth, the positive electrode with transition metal oxide material can store a substantial amount of charges therein and on its surface via rapid oxidation-reduction cycles.

Fifth, the transition metal oxide layer/transition metal oxide material can act as a pseudo-capacitor of the capacitor unit C.

Based on the above, the capacitor unit can be widely used in urban public transportation, wind power generation, hybrid bus, smart power grid, engineering machinery and other fields.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A capacitor unit with high-energy storage:
an electrolyte;
a positive electrode arranged in the electrolyte, having a substrate and a transition metal oxide layer formed on the substrate; and
a negative electrode arranged in the electrolyte corresponding to the positive electrode.

2. The capacitor unit with high-energy storage according to claim 1, wherein the substrate is a porous metal substrate.

3. The capacitor unit with high-energy storage according to claim 2, wherein the porous metal substrate is an aluminum foam structure, a nickel foam structure, or a titanium foam structure.

4. The capacitor unit with high-energy storage according to claim 1, wherein the transition metal oxide layer is made from manganese oxide (MnO₂), nickel oxide (NiO), cobalt oxide (Co₃O₄), vanadium oxide (V₂O₅), iridium oxide (IrO₂), or rubidium oxide (RuO₂).

5. The capacitor unit with high-energy storage according to claim 1, the electrolyte is a gel electrolyte.

6. The capacitor unit with high-energy storage according to claim 5, wherein the gel electrolyte comprises an electrically conductive polymer composition.

7. The capacitor unit with high-energy storage according to claim 6, wherein the electrically conductive polymer composition comprises at least one inherently conductive polymer or copolymer selected from polypyrroles, polythiophenes, polyacetylenes, polyphenylenes, polystyrenes, polyanilines, polyacenes, polythienylenevinylenes, and their derivatives.

8. The capacitor unit with high-energy storage according to claim 7, wherein the electrically conductive polymer composition comprises an organic salt, a polyanion, ceramic particles, or the combination thereof.

9. The capacitor unit with high-energy storage according to claim 1, wherein the electrolyte is a water-soluble electrolyte.

10. The capacitor unit with high-energy storage according to claim 9, wherein the water-soluble electrolyte comprises an electrically conductive polymer composition.

11. The capacitor unit with high-energy storage according to claim 10, wherein the electrically conductive polymer composition comprises at least one inherently conductive polymer or copolymer selected from polypyrroles, polythiophenes, polyacetylenes, polyphenylenes, polystyrenes, polyanilines, polyacenes, polythienylenevinylenes, and their derivatives.

12. The capacitor unit with high-energy storage according to claim 11, wherein the electrically conductive polymer composition comprises an organic salt, a polyanion, ceramic particles, or the combination thereof.

13. The capacitor unit with high-energy storage according to claim 1, further comprising two collectors spaced apart from each other, each of which is a porous metal body, and the positive electrode and the negative electrode are arranged on the surfaces of the two collectors respectively.

14. The capacitor unit with high-energy storage according to claim 13, further comprising a separator arranged between the positive electrode and the negative electrode.

15. A capacitor unit with high-energy storage:
an electrolyte;
a positive electrode arranged in the electrolyte and made of a mixture of a porous carbon material and a nano-scaled transition metal oxide material; and
a negative electrode arranged in the electrolyte corresponding to the positive electrode.

16. The capacitor unit with high-energy storage according to claim 15, wherein the porous carbon material is made from graphene, carbon nanotubes, carbon nanofibers, or carbon nanocapsules.

17. The capacitor unit with high-energy storage according to claim 15, wherein the transition metal oxide material is made from manganese oxide (MnO₂), nickel oxide (NiO), cobalt oxide (Co₃O₄), vanadium oxide (V₂O₅), iridium oxide (IrO₂), or rubidium oxide (RuO₂).

18. The capacitor unit with high-energy storage according to claim 15, wherein the electrolyte is a gel electrolyte.

19. The capacitor unit with high-energy storage according to claim 18, wherein the gel electrolyte comprises an electrically conductive polymer composition.

20. The capacitor unit with high-energy storage according to claim 19, wherein the electrically conductive polymer composition comprises at least one inherently conductive polymer or copolymer selected from polypyrroles, polythiophenes, polyacetylenes, polyphenylenes, polystyrenes, polyanilines, polyacenes, polythienylenevinylenes, and their derivatives.

21. The capacitor unit with high-energy storage according to claim 20, wherein the electrically conductive polymer composition comprises an organic salt, a polyanion, ceramic particles, or the combination thereof.

22. The capacitor unit with high-energy storage according to claim 15, wherein the electrolyte is a water-soluble electrolyte.

23. The capacitor unit with high-energy storage according to claim 22, wherein the water-soluble electrolyte comprises an electrically conductive polymer composition.

24. The capacitor unit with high-energy storage according to claim 23, wherein the electrically conductive polymer composition comprises at least one inherently conductive polymer or copolymer selected from polypyrroles, polythiophenes, polyacetylenes, polyphenylenes, polystyrenes, polyanilines, polyacenes, polythienylenevinylenes, and their derivatives.

25. The capacitor unit with high-energy storage according to claim 24, wherein the electrically conductive polymer composition comprises an organic salt, a polyanion, ceramic particles, or the combination thereof.

26. The capacitor unit with high-energy storage according to claim 15, further comprising two collectors spaced apart from each other, each of which is a porous metal body, and the positive electrode and the negative electrode are arranged on the surfaces of the two collectors respectively.

27. The capacitor unit with high-energy storage according to claim 26, further comprising a separator arranged between the positive electrode and the negative electrode.
